(19) United States
(12) Patent Application Publication
(10) Pub. No.: US 2026/0219239 A1
(43) Pub. Date: Jul. 30, 2026

(54) NONDESTRUCTIVE INSPECTION DEVICE, NONDESTRUCTIVE INSPECTION METHOD, AND NONDESTRUCTIVE INSPECTION PROGRAM

(71) Applicant: Konica Minolta, Inc., Tokyo (JP)

(72) Inventors: Junko YOSHIDA, Hyogo (JP); Mizuho NISHI, Kyoto (JP); Masaru FUSE, Osaka (JP)

(21) Appl. No.: 19/151,744

(22) PCT Filed: Jan. 31, 2024
(86) PCT No.: PCT/JP2024/003131

§ 371 Date: Jul. 29, 2025

(30) Foreign Application Priority Data
Feb. 8, 2023 (JP) 2023-017659

(51) Int. Cl. G01N 29/44

(52) U.S. Cl. CPC G01N 29/4445; G01N 2291/0289

(57) ABSTRACT

A nondestructive inspection device comprising: a transmission unit that transmits waves toward an object; a reception unit that receives the reflected waves; and a detection unit that uses waves that are from among the reflected waves and have been reflected multiple times off multiple interfaces including the outer surface of the object to acquire internal information of the object and, on the basis of the internal information, detects a flaw in the object.

### TECHNICAL FIELD

The present invention relates to a nondestructive inspection device, a nondestructive inspection method, and a nondestructive inspection program.

### BACKGROUND ART

In various industrial fields, techniques for more easily evaluating the quality and characteristics of products have been developed.

The visual inspection is the most popular method for evaluating the quality and the like of a product, but it is naturally impossible to examine the internal state of the product, and it is impossible to detect structural deterioration or defect. For this reason, in the manufacturing process, quality check in the final step such as shipping inspection is a main application, and even if a defect is detected, it is difficult to approach the problem detection, improvement, or the like of the step.

A method using waves such as sound waves or electromagnetic waves, for example, an ultrasound method, can determine the internal structure of a product safely, easily, and inexpensively, and is therefore one of the mainstream nondestructive inspection methods. This method transmits waves to a target, and observes resulting reflected waves or transmitted waves. For example, PTL 1 discloses an ultrasound flaw detection device that detects a defect existing inside a target by using ultrasound transmitted through the target.

### CITATION LIST

### Patent Literatures

PTL 1

Japanese Unexamined Patent Publication No. 2006-177872

### SUMMARY OF INVENTION

### Technical Problem

In a method using waves such as sound waves and electromagnetic waves, such as an ultrasound method, it is difficult to detect a defect or the like inside a target depending on the position of the defect or the like. Further, there is also a problem that appropriate know-how and knowledge are required in order to use such a method for an inspection and evaluation process, and thus further simplification is required.

For example, in the ultrasound method, there is a method of detecting the presence and position of a defect or the like based on the magnitude of the transmission intensity or the reflection intensity by making use of the fact that the intensity of ultrasound incident on a target and transmitted or reflected is attenuated by being scattered due to the presence of an internal defect or the like.

In such a method, since the transmittance varies depending on the target, it is difficult to optimize the transmission/reception level. Further, it is difficult to distinguish a defect in a deep portion in the vicinity of the back surface of the target because the reflected wave from the defect in the deep portion and the reflected wave from the back surface are temporally close to each other, and it is difficult to detect the defect. Therefore, it is desired to more simply detect a defect or the like inside a target even without special know-how or knowledge.

It is an object of the present invention to provide a nondestructive inspection device, a nondestructive inspection method, and a nondestructive inspection program capable of more simply detecting a defect inside a target.

### Solution to Problem

A nondestructive inspection device according to the present invention includes: a transmitter that transmits a wave to a target; a receiver that receives the wave that is reflected; and a detector that acquires internal information on the target based on the wave reflected a plurality of times in the wave that is reflected and detects a defect inside the target based on the internal information, the wave reflected the plurality of times being reflected the plurality of times between a plurality of interfaces including an outer surface of the target.

A nondestructive inspection method according to the present invention includes: transmitting a wave to a target; receiving the wave that is reflected; and acquiring internal information on the target based on the wave reflected a plurality of times in the wave that is reflected and detecting a defect inside the target based on the internal information, the wave reflected the plurality of times being reflected the plurality of times between a plurality of interfaces including an outer surface of the target.

A nondestructive inspection program according to the present invention causes a computer to execute: a process of transmitting a wave to a target; a process of receiving the wave that is reflected; and a process of acquiring internal information on the target based on the wave reflected a plurality of times in the wave that is reflected and detecting a defect inside the target based on the internal information, the wave reflected the plurality of times being reflected the plurality of times between a plurality of interfaces including an outer surface of the target

### Advantageous Effects of Invention

According to the present invention, a defect inside a target can be detected more easily.

### BRIEF DESCRIPTION OF THE DRAWINGS

FIG. 1 is a diagram schematically illustrating an example of a configuration of a nondestructive inspection device according to an embodiment of the present invention.

FIG. 2 is a diagram illustrating a propagation state of a wave input to a target by an internal information acquirer of the nondestructive inspection device illustrated in FIG. 1.

FIG. 3 is a diagram illustrating a reception signal received by an internal information acquirer of the nondestructive inspection device illustrated in FIG. 1 in the form of a tomographic image formed on the basis of the signal.

FIG. 4 is a diagram illustrating an example of a planar cross-sectional image formed on the basis of the reception signal (multiple reflection signal) illustrated in FIG. 3.

FIG. 5 is a flowchart for explaining an example of a nondestructive inspection method in the nondestructive inspection device illustrated in FIG. 1.

FIG. 6 is a diagram schematically illustrating a modification example (modification example 1) of the nondestructive inspection method illustrated in FIG. 1.

FIG. 7 is a flowchart for explaining a modification example (modification example 2) of the nondestructive inspection method illustrated in FIG. 5.

FIG. 8 is a diagram schematically illustrating a modification example (modification example 3) of the nondestructive inspection device illustrated in FIG. 1.

FIG. 9 is a diagram illustrating a propagation state of a wave input to a target by an internal information acquirer of the nondestructive inspection device illustrated in FIG. 8.

FIG. 10 is a diagram schematically illustrating a modification example (modification example 4) of the nondestructive inspection device illustrated in FIG. 1.

FIG. 11 is a diagram illustrating a propagation state of a wave input to a target by an internal information acquirer of the nondestructive inspection device illustrated in FIG. 10.

FIG. 12 is a diagram schematically illustrating a modification example (modification example 5) of the nondestructive inspection device illustrated in FIG. 1.

FIG. 13 is a flowchart for explaining an example of a nondestructive inspection method in the nondestructive inspection device illustrated in FIG. 12.

FIG. 14 is a diagram illustrating an example of a configuration in which the nondestructive inspection device according to the embodiment of the present invention is applied to a shaping work by means of a 3D printer.

### DESCRIPTION OF EMBODIMENTS

Hereinafter, embodiments of the present invention will be described in detail with reference to the drawings.

### Nondestructive Inspection Device

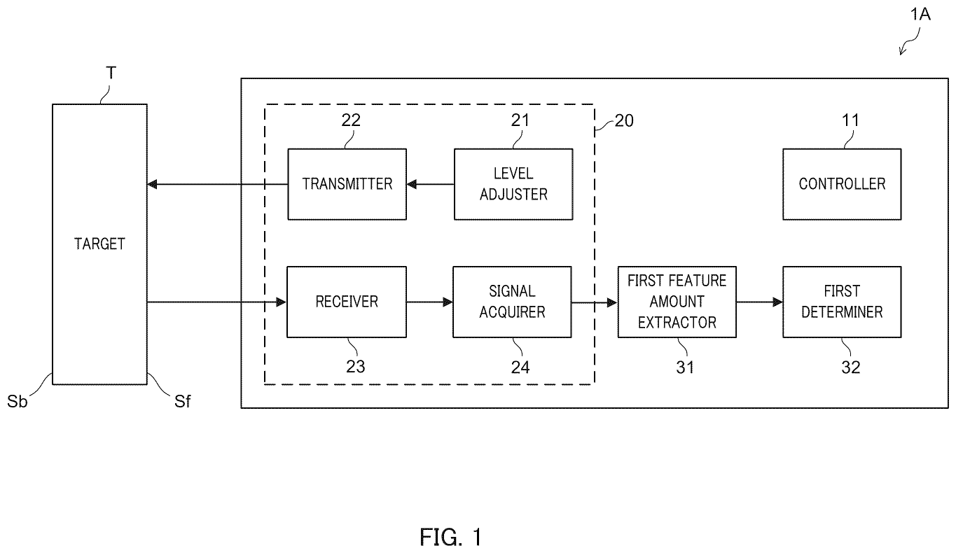

FIG. 1 is a diagram schematically illustrating an example of a configuration of a nondestructive inspection device LA according to the present embodiment.

The nondestructive inspection device 1A is an device that transmits waves to a target T, receives reflected waves, acquires internal information on the target T based on the reflected waves, and inspects the inside of the target T in a nondestructive manner based on the acquired internal information.

Here, ultrasound will be described as an example of the waves to be transmitted to the target T. Note that in the present embodiment, any of acoustic wave including ultrasound, electromagnetic wave, and light wave can be used as the wave. That is, it is sufficient that these waves can be transmitted through and reflected by the target T.

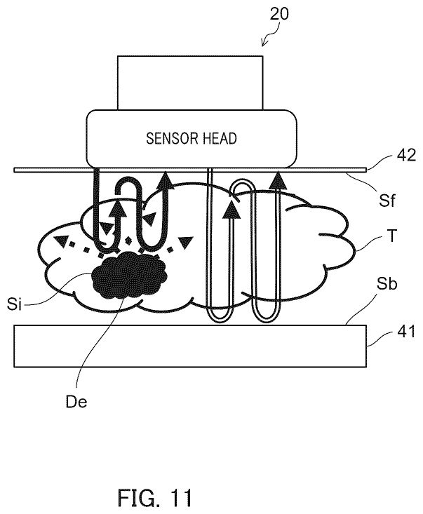

The target T is a solid object as an example, but is not limited thereto, and may be in the form of liquid or gas. In addition, the shape of the target T is a rectangular parallelepiped as an example, but is not limited thereto, and may be a sphere, an ellipsoid, a cylinder, an elliptic cylinder, a prism, or the like, and may be an irregular shape or the like as illustrated in FIG. 11 described later.

As illustrated in FIG. 1, the nondestructive inspection device 1A includes a controller 11, an internal information acquirer 20, a first feature amount extractor 31, a first determiner 32, and the like, and although not illustrated, includes a display, an operation inputter, and the like.

The controller 11 is, for example, a device such as a computer including, for example, a central processor (CPU), a read only memory (ROM), and a random access memory (RAM).

For example, the controller 11 controls the internal information acquirer 20, the first feature amount extractor 31, the first determiner 32, and the like by the CPU referring to a control program or various data stored in the ROM or the RAM and executing the control program, and implements each function.

Note that some or all of these functions may be implemented by an application specific integrated circuit (ASIC), a digital signal processor (DSP), a programmable logic device (PLD), a dedicated hardware circuit, or the like. The PLD includes a field programmable gate array (FPGA) or the like. Further, some or all of these functions may be configured to be executed by a graphics processing unit (GPU).

The internal information acquirer 20 transmits ultrasound to the target T, receives a reflected ultrasound, and acquires internal information on the target T on the basis of the reflected ultrasound. As illustrated in FIG. 1, the internal information acquirer 20 includes a level adjuster 21, a transmitter 22, a receiver 23, and a signal acquirer 24.

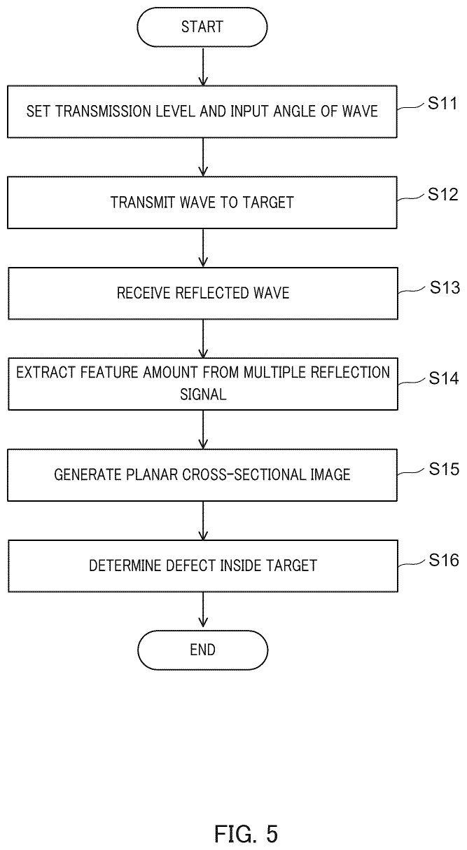

The level adjuster 21 adjusts the transmission level (transmission intensity) of the ultrasound transmitted from the transmitter 22. The transmitter 22 transmits ultrasound to the target T. The transmitter 22 inputs ultrasound from a first surface Sf of a plurality of surfaces forming the outer surface of the target T. In the present embodiment, multiple reflection, which will be described later, occurs inside the target T, and the transmission level of the ultrasound is adjusted so that the wave due to the reflection can be received by the receiver 23. Further, as will be described later with reference to FIG. 5, the input angle of the ultrasound with respect to the target T may be adjusted.

The receiver 23 receives the ultrasound reflected from the target T side and converts the ultrasound into a reception signal. Specifically, the receiver 23 receives the ultrasound reflected from the target T side, including the ultrasound reflected a plurality of times between a plurality of interfaces including the outer surface of the target T, and converts the ultrasound into a reception signal.

Here, among the reflected ultrasound, a reception signal acquired by receiving and converting the ultrasound reflected (multiply reflected) a plurality of times between the first surface Sf and a second surface Sb different from the first surface Sf among the plurality of surfaces forming the outer surface of an target T is referred to as a first reception signal. In the target T, it is desirable that the first surface Sf and the second surface Sb face each other in a parallel manner or a substantially parallel manner. When the first surface Sf is a surface of the target T, the second surface Sb is a back surface of the target T.

The transmitter 22 and the receiver 23 are arranged so that a first effective distance based on a first distance between an ultrasound input/output end surface of the transmitter 22 and the receiver 23 and the first surface Sf is not N times a second effective distance based on a second distance between the first surface Sf and the second surface Sb described later when a signal component corresponding to the ultrasound reflected N times by the second surface Sb is used to acquire a signal component representing internal information by the signal acquirer 24 described later. Here, N is a natural number. The first effective distance is a distance based on the first distance and the refractive index of the space between the input/output end surface and the first surface Sf. The second effective distance is a distance based on the second distance and the refractive index of the target T. With such an arrangement, a reception signal due to N times of reflection on the second surface Sb and a reception signal due to multiple reflection between the transmitter 22 and the receiver 23 and the first surface Sf do not overlap each other on the time axis, that is, can be separated on the time axis. More practically, it is desirable that the transmitter 22 and the receiver 23 are brought into close contact with the first surface Sf as much as possible, or the first effective distance is larger than N times the second effective distance.

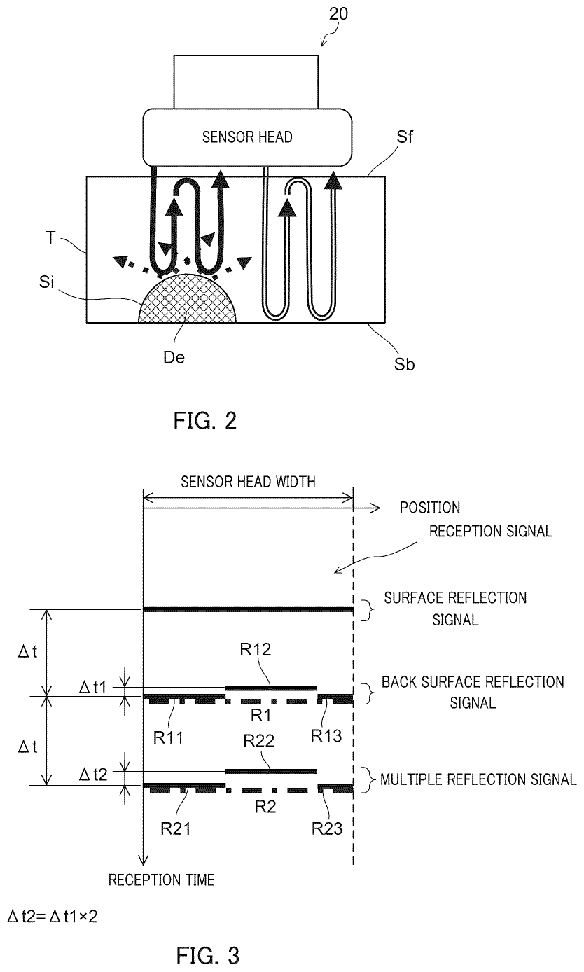

In the present embodiment, the transmitter 22 and the receiver 23 are, for example, acoustic sensors that transmit ultrasound to the target T, receive ultrasound echoes reflected from the target T side, and convert the ultrasound echoes into reception signals (electrical signals). The acoustic sensor includes a transducer formed of a piezoelectric element. For example, a plurality of transducers are arranged in a one dimensional array in an azimuth direction (scanning direction) to form a sensor head (see FIG. 2 described later). In the above configuration, the transmitter 22 transmits, for example, a plane wave, that is, ultrasound having a wavefront in a direction perpendicular to the transmission direction, as the wavefront shape of the ultrasound to be transmitted. Note that the configurations of the transmitter 22 and the receiver 23, the wavefront shape of ultrasound to be transmitted, and the like are not limited thereto, and the wavefront shape may be a spherical wave or the like.

The signal acquirer 24 acquires a signal component representing the internal information from the signal received and converted by the receiver 23. Here, the signal component acquired from the first reception signal is referred to as a first signal component.

The first feature amount extractor 31 extracts a feature amount related to a defect inside the target T from the signal component acquired by the signal acquirer 24. Here, the feature amount extracted from the first signal component is referred to as a first feature amount. Note that in the present embodiment, the defect includes a flaw, a crack, internal peeling, a foreign substance, and the like.

The first determiner 32 forms a cross-sectional image in a plane along a direction orthogonal to the input direction of the ultrasound on the basis of the feature amount extracted by the first feature amount extractor 31, and determines the presence of a defect inside the target T. Here, the first determiner 32 forms a planar cross-sectional image in a plane along a direction orthogonal to the input direction of the ultrasound on the basis of the first feature amount described above, and determines the presence of a defect inside the target T.

In addition, the first determiner 32 may form contour data obtained by differentiating the data of the planar cross-sectional image in the direction orthogonal to the input direction of the ultrasound, and determine the presence of a defect inside the target T.

Here, the first determiner 32 determines the presence of a defect inside the target T using the first reception signal based on the multiply reflected ultrasound. The present invention is not limited thereto, and the first determiner 32 may determine the presence of a defect inside the target T by also using the second reception signal based on the ultrasound reflected once by the inside of the target T and the second surface Sb among the inside of the target T, the first surface Sf, and the second surface Sb. By increasing the number of variables for determination, the accuracy of determination of the presence of a defect can be improved.

The signal acquirer 24, the first feature amount extractor 31, and the first determiner 32 constitute a detector in the present invention. The detector acquires internal information on the target T on the basis of the reflected ultrasound, in particular, on the basis of the ultrasound reflected a plurality of times between a plurality of interfaces including the outer surface of the target T, and detects a defect inside the target T on the basis of the internal information.

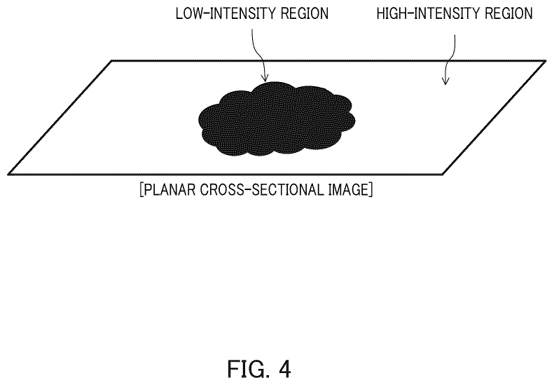

The display (not illustrated) displays a cross-sectional image (for example, a planar cross-sectional image illustrated in FIG. 4 described later) generated by the first determiner 32. As the display, for example, a liquid crystal display, an organic EL display, a CRT display, a touch screen, or the like can be used.

The operation inputter (not illustrated) is a user interface for a user to perform an input operation, converts the input operation performed by the user into operation information, and inputs the operation information to the controller 11. The operation inputter includes, for example, an operation panel having a plurality of input switches, a keyboard, and a mouse. When a touch screen is used as the display, the touch screen also functions as a part of the operation inputter.

With the above-described configuration, the nondestructive inspection device 1A transmits ultrasound to the target T, receives reflected ultrasound, acquires internal information on the target T based on the reflected ultrasound, inspects the inside of the target T based on the acquired internal information, and detects a defect.

Now, with reference to FIG. 2 to FIG. 4, the following describes the acquisition of the internal information on the inside of the target T, the acquired reception signals, and the planar cross-sectional image (the cross-sectional image in the present invention) formed based on the reception signals.

FIG. 2 is a diagram illustrating a propagation state of waves input to the target T by the internal information acquirer 20 of the nondestructive inspection device 1A. FIG. 3 is a diagram illustrating a reception signal received by the internal information acquirer 20 of the nondestructive inspection device 1A in the form of a tomographic image formed on the basis of the signal. FIG. 4 is a diagram illustrating an example of a planar cross-sectional image formed on the basis of the reception signal (multiple reflection signal) illustrated in FIG. 3.

The internal information acquirer 20 transmits ultrasound to the target T, receives the reflected ultrasound, and acquires the internal information on the target T based on the ultrasound reflected a plurality of times between a plurality of interfaces including the outer surface of the target T among the reflected ultrasound.

For example, as illustrated in FIG. 2, the ultrasound (double-line arrow) transmitted from the transmitter 22 of the internal information acquirer 20 to the target T is reflected a plurality of times between the first surface Sf (front surface) and the second surface Sb (back surface) of the target T, and is received by the receiver 23.

As illustrated in FIG. 2, when there is a defect De inside the target T, the ultrasound (thick arrow) transmitted from the transmitter 22 to the target T is reflected a plurality of times between the first surface Sf and an interface Si between the target T and the defect De, and is received by the receiver 23.

The ultrasound received by the receiver 23 is converted into a reception signal (electrical signal). FIG. 3 is an example in which the reception signal is two dimensionally illustrated with the width direction of the sensor head as the horizontal direction and the time axis corresponding to the position (depth direction) inside the target T as the vertical direction. In FIG. 3, positions at which the reception signal is particularly strongly detected are illustrated as R11 to R13 and R21 to R23. Here, the reception signals R11 to R13 and R21 to R23 are signals having information on intensities, phases, frequencies, spatial frequencies, and the like of the corresponding ultrasound, and change according to transmission, reflection, scattering, and the like of the ultrasound. The spatial frequency is a wave number included in a unit length in a plane along a direction orthogonal to the input direction of the ultrasound.

As illustrated in FIG. 3, at a reception time corresponding to a propagation time from the transmitter 22 and the receiver 23 to a predetermined position inside the target T, the ultrasound from the predetermined position is converted into a reception signal, or at a reception time corresponding to the number of times of reflection of the ultrasound, the ultrasound is converted into a reception signal. Therefore, the time at which the strong ultrasound is received varies depending on the presence or absence of the defect De and the position thereof.

For example, in FIG. 3, the back surface reflection signal is the reception signal R1 obtained by converting the ultrasound transmitted from the transmitter 22, reflected once by the second surface Sb, and then received by the receiver 23, that is, the ultrasound that have reciprocated once between the first surface Sf and the second surface Sb, and R11 and R13 represent a part thereof. The multiple reflection signal (first reception signal in the present invention) is the reception signal R2 obtained by converting the ultrasound reflected a plurality of times (twice in FIG. 3) between the first surface Sf and the second surface Sb, that is, the ultrasound that have reciprocated twice between the first surface Sf and the second surface Sb, and R21 and R23 represent a part thereof. Further, R12 represents a reception signal acquired by converting the ultrasound reflected once at the interface Si of the defect De, that is, the ultrasound that have reciprocated once between the first surface Sf and the interface Si. In addition, R22 represents a reception signal acquired by converting ultrasound reflected a plurality of times (twice in FIG. 3) between the first surface Sf and the interface Si of the defect De, that is, the ultrasound that have reciprocated twice between the first surface Sf and the interface Si (refer also to FIG. 2).

As illustrated in FIG. 3, it is assumed that reception signals R11 and R13 are back surface reflection signals received when there is no defect or the like inside T, and are detected at a time At after the surface reflection signal. In this case, the reception signals R21 and R23 corresponding to the multiply-reflected ultrasound are observed with a further delay of At from the reception times of the reception signals R11 and R13. In FIG. 3, reception signals R21 and R23 obtained by converting ultrasound reflected once by the first surface Sf and twice by the second surface Sb, that is, ultrasound that have reciprocated twice between the first surface Sf and the second surface Sb are illustrated as multiple reflection signals. When the number of times of reflection (the number of times of reciprocation between the first surface Sf and the second surface Sb) is N, the reception time is delayed by Δt×N from the front surface reflection signal. As described above, it is possible to determine whether the reflection is the back surface reflection or the multiple reflection, and what number of times the multiple reflection is performed, based on the reception time, and it is possible to extract the multiple reflection signal from the reception signal by setting an appropriate reception time. In the present embodiment, the sensor head of the internal information acquirer 20 is moved, for example, in a direction orthogonal to the width direction of the sensor head along the first surface Sf of the target T, whereby not only one dimensional scanning in the width direction but also two dimensional scanning can be performed.

In this manner, it is possible to determine the presence of the defect De inside the target T by forming the planar cross-sectional image illustrated in FIG. 4 using the multiple reflection signal acquired by performing the two dimensional scanning.

That is, among the reception signals R2 at the time corresponding to the ultrasound multiply reflected between the first surface Sf and the second surface Sb, the reception signals R21 and R23 at the place without the defect De have relatively high intensity, and the intensity is low or no reception signal is detected at the place with the defect De. The time difference between the reception signal R2 and the reception signal R22 is twice the time difference between the reception signal RI and the reception signal R12, and it is considered that the presence of absence of the defect De is more prominently expressed in the reception signal R2 than in the reception signal R1.

The planar cross-sectional image illustrated in FIG. 4 is formed using such an intensity of the reception signal R2. That is, the detector (the signal acquirer 24, the first feature amount extractor 31, and the first determiner 32) acquires the first signal components from the intensity of the reception signal R2, extracts the first feature amounts from the first signal components, and forms the planar cross-sectional image illustrated in FIG. 4 on the basis of the first feature amounts.

By forming (map-displaying) the planar cross-sectional image as illustrated in FIG. 4, the first determiner 32. can determine the defect De inside the target T, for example, determine that the defect De is present in the low-intensity region. The first determiner 32 can also determine the shape, size, and the like of the defect De.

In this manner, the nondestructive inspection device 1A determines the presence or the like of the defect De inside the target T by using the multiple reflection. In general, when a wave is incident on the target T having a flat outer surface, reflection occurs significantly depending on the material. In addition, in a case where there are a plurality of planar portions and the planar portions face each other, multiple reflection in which a wave is reflected and reciprocated therebetween a plurality of times is generated. Although the multiple reflection is generally treated as an unnecessary component in observing normal wave propagation, the multiple reflection which has been in the related art considered to be unnecessary is used in the present embodiment.

Specifically, for example, if there is a crack, delamination, or the like as the defect De on the surface or the inside or the back surface of the target T, the transmission loss increases and the multiple reflection attenuates at that portion because most of the interfaces have an uneven shape. Further, in general, the larger the input energy is, the more prominently the multiple reflection is observed. In the present embodiment, by utilizing such a characteristic, it is possible to simply determine the presence or absence of the defect De inside the target T or perform screening described later, by the intensity of the multiple reflection.

Note that the signal acquirer 24 and the first feature amount extractor 31 may acquire the first signal components from the phases, frequencies, spatial frequencies, or the like of the reception signals R2 instead of the intensities of the reception signals R2 and may extract the first feature amounts from the first signal components. Further, the signal acquirer 24 and the first feature amount extractor 31 may acquire the first signal components based on any two or more of the intensities, the phases, the frequencies, and the spatial frequencies of the reception signals R2, and may extract the first feature amounts from the first signal components.

### Nondestructive Inspection Method

A nondestructive inspection method in the nondestructive inspection device 1A will be described with reference to FIG. 5 together with FIGS. 1 to 4. FIG. 5 is a flowchart for explaining an example of a nondestructive inspection method in the nondestructive inspection device 1A. The nondestructive inspection method in the nondestructive inspection device 1A is performed by the controller 11 executing a nondestructive inspection program. Note that in FIG. 5, description will be given using ultrasound as waves.

### Step S11

The controller 11 controls the level adjuster 21 to set the transmission level of the ultrasound to be transmitted from the transmitter 22. Further, the controller 11 controls an angle adjuster, which is not illustrated in the drawing, to set an input angle of the ultrasound with respect to the target T. For example, the angle of the sensor head illustrated in FIG. 2 is configured to be adjustable, and the angle of the sensor head with respect to the target T is set to an appropriate angle (for example, an angle at which the sensor head surface directly faces the first surface Sf or the second surface Sb, or another predetermined angle) by the angle adjuster.

### Step S12

The controller Il controls the transmitter 22 to transmit ultrasound to the target T. At this time, ultrasound is transmitted to the target T at the transmission level and the input angle set in step S11.

### Step S13

The controller 11 controls the receiver 23 to receive the ultrasound reflected from the target T side. At this time, the receiver 23 selects the ultrasound reflected a plurality of times between the first surface Sf and the second surface Sb of the target T among the reflected ultrasound, and converts the ultrasound into a multiple reflection signal (first reception signal).

### Step S14

The controller 11 controls the signal acquirer 24 and the first feature amount extractor 31 to acquire the first signal component representing the internal information from the multiple reflection signal and extract the first feature amount from the signal component.

### Step S15

The controller 11 controls the first determiner 32 to form, based on the first feature amount, a planar cross-sectional image in a plane along a direction orthogonal to the input direction of the ultrasound.

### Step S16

The controller 11 controls the first determiner 32 to determine the presence of the defect De inside the target T in the formed planar cross-sectional image. At this time, the position, shape, size, and the like of the defect De may be determined.

According to the sequence described above, the nondestructive inspection device 1A can easily determine the presence of a defect inside the target T using the multiple reflection signal.

### Conclusion

As described above, in the present embodiment, the nondestructive inspection device 1A includes the transmitter 22, the receiver 23, and the detector (the signal acquirer 24, the first feature amount extractor 31, and the first determiner 32). The transmitter 22 transmits waves to the target T, and the receiver 23 receives the reflected waves. The detector acquires internal information on the target T on the basis of the waves reflected a plurality of times between a plurality of interfaces including the outer surface of the target T out of the reflected waves and detects a defect inside the target on the basis of the internal information.

According to the nondestructive inspection device 1A of the present embodiment configured as described above, since the multiple reflection signal is used, it is possible to more simply detect the defect De inside the target T.

### Modification Example 1

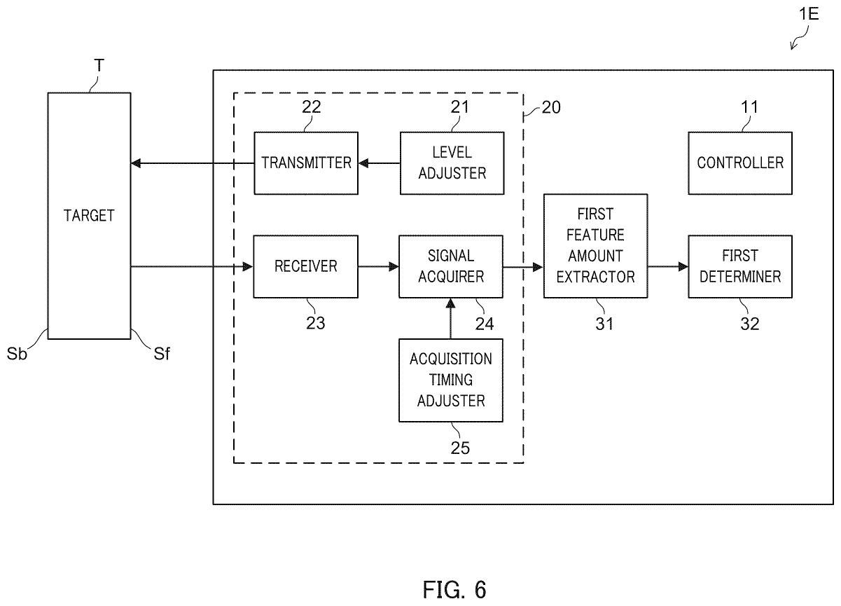

FIG. 6 is a diagram schematically illustrating a nondestructive inspection device 1E that is a modification example of the nondestructive inspection device 1A. Also in the present modification example, description will be given using ultrasound as a wave.

The nondestructive inspection device 1E basically has the same configuration as that of the nondestructive inspection device 1A. However, the nondestructive inspection device 1E is different from the nondestructive inspection device 1A in that it further includes an acquisition timing adjuster 25 in addition to the nondestructive inspection device 1A. The acquisition timing adjuster 25 provides a signal or information indicating at least one of an appropriate timing and a time window to the signal acquirer 24, and thus it is possible to improve the detection performance of the multiple reflection signal.

Hereinafter, the operation of the nondestructive inspection device 1E will be described with reference to FIG. 3.

As described above, in FIG. 3, the reception signals R11 and R13 are signals corresponding to the ultrasound reflected once by the second surface Sb of the target T (see also FIG. 2). The reception signal R12 is a signal corresponding to the ultrasound reflected once at the defect De inside the target T (see also FIG. 2). Further, as illustrated in FIG. 3, the reception time of the reception signal R12 corresponding to the ultrasound reflected once by the defect De is observed earlier than the reception times of the reception signals R11 and R13 corresponding to the ultrasound reflected once by the second surface Sb, and there is a time difference Δt1.

Similarly, in FIG. 3, reception signals R21 and R23 are signals corresponding to the ultrasound multiply reflected by the second surface Sb (see also FIG. 2). Further, the reception signal R22 is a signal corresponding to the ultrasound multiply reflected by the defect De (see also FIG. 2). As illustrated in FIG. 3, the reception time of the reception signal R22 corresponding to the ultrasound multiply reflected by the defect De is observed earlier than the reception times of the reception signals R21 and R23 corresponding to the ultrasound multiply reflected by the second surface Sb, and there is a time difference Δt2. The time difference Δt2 is larger than the above-described time difference Δt1, and this time difference further increases as the number of times of reflection increases, and the temporal separability between the reflection signal on the second surface Sb of the target T and the reflection signal on the defect De increases.

The acquisition timing adjuster 25 adjusts, for reception signals corresponding to multiply-reflected ultrasound, at least one of the acquisition timing and the acquisition time length in accordance with the signal position and signal duration of the multiply-reflected signal and a time difference corresponding to the number of reflections, which is exemplified by the above-described time difference Δt2. As a result, the influence of the defect De on the multiple reflection signal, that is, the attenuation effect by the defect De is further increased, and the separability from the normal portion can be improved.

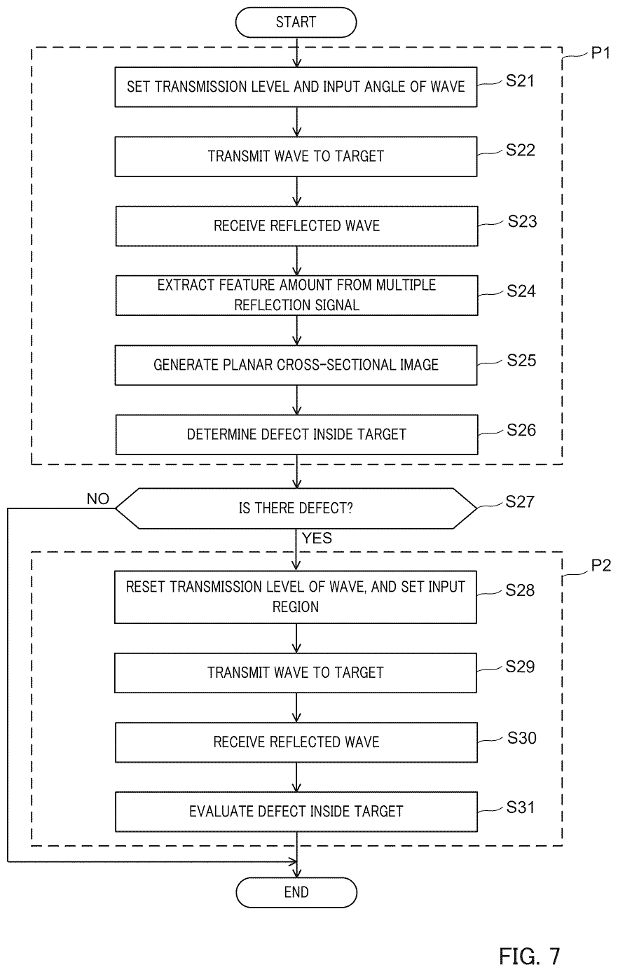

In this manner, the nondestructive inspection device 1E can substantially increase the resolution with respect to the reception signal and more clearly detect the defect De inside the target T. The nondestructive inspection device 1E can perform a nondestructive inspection method illustrated in FIG. 5 or FIG. 7 described later as the nondestructive inspection method.

### Modification Example 2

In this modification example, the above-described nondestructive inspection device 1A is used as the device. However, the nondestructive inspection method performed by the nondestructive inspection device 1A is different from the nondestructive inspection method illustrated in FIG. 5, and a screening process for grasping the position of the defect De and an evaluation process for evaluating the details of the defect De are performed.

### Nondestructive Inspection Method

A nondestructive inspection method of the present modification example in which screening processing and evaluation processing are performed will be described with reference to FIG. 7 together with FIGS. 1 to 4. FIG. 7 is a flowchart for explaining another example of the nondestructive inspection method illustrated in FIG. 5. The nondestructive inspection method of the present modification example is also performed by the controller 11 executing a nondestructive inspection program. Note that also in FIG. 7, description will be given using ultrasound as a wave.

### Step S21

The controller 11 controls the level adjuster 21 to adjust the transmission level of the ultrasound transmitted from the transmitter 22. Further, the controller 11 controls the angle adjuster, which is not illustrated in the drawing, to adjust the input angle of the ultrasound with respect to the target T.

Step S21 is basically the same as the above-described step S11. Provided that in step S21, the transmission level of ultrasound is adjusted to an intensity equal to or higher than a predetermined intensity in order to grasp the position of the defect De in steps S21 to S26 in which screening processing P1 is performed. The predetermined intensity is, for example, an intensity at which a signal level of the ultrasound reflected once on the second surface Sb at the receiver 23 or the signal acquirer 24 is an upper limit signal level allowed at the receiver 23 or the signal acquirer 24. In a case where the transmission level of the ultrasound is set to an intensity higher than the predetermined intensity, the signal level of the ultrasound reflected once by the second surface Sb in the receiver 23 or the signal acquirer 24 exceeds the upper limit signal level and is saturated. As described above, in order to grasp the presence of the defect De or the position thereof, ultrasound having an intensity as high as possible is used.

### Steps S22 to S2

Steps S22 to S25 are the same as the above-described steps S12 to S15, and therefore the overlapping description will be omitted here.

### Step S26

The controller 11 controls the first determiner 32 to determine the presence of the defect De inside the target T in the formed planar cross-sectional image and determine the presence or the position of the defect De.

### Step S27

When there is the defect De (YES), the controller 11 proceeds to step S28, and when there is no defect De (NO), the controller 11 ends the series of processes.

### Step S28

The controller 11 controls the level adjuster 21 to reset the transmission level of the ultrasound to be transmitted from the transmitter 22 and set the input region.

In steps S28 to S31 in which evaluation processing P2 is performed in step S28, in order to evaluate the defect De in detail, unlike step S21, the transmission level of the ultrasound is set to, for example, a level (intensity) less than the above-described predetermined intensity. That is, since ultrasound having an intensity less than a predetermined intensity at which the intensity of the ultrasound reflected once by the second surface Sb is not saturated is used, the reflection intensity of the ultrasound reflected to the receiver 23 linearly changes according to the difference in reflection, scattering, or the like at the interface Si of the defect De. Thus, the defect De can be evaluated in detail.

Further, since the position of the defect De is grasped in step S26, the input region of the ultrasound is set in step S28. As a result, it is possible to narrow down the area to be inspected and evaluate the defect De in detail.

### Step S29

The controller 11 controls the transmitter 22 to transmit ultrasound to the target T. At this time, the ultrasound is transmitted to the set input region of the target T at the transmission level reset in step S28.

### Step S30

The controller 11 controls the receiver 23 to receive the ultrasound reflected from the target T side. At this time, the receiver 23 converts the ultrasound received by the time when the ultrasound is reflected once by the second surface Sb of the target T among the reflected ultrasound into a reception signal (third reception signal).

### Step S31

The controller 11 controls the signal acquirer 24 and the analyzer 33 to extract the internal information from the third reception signal by a predetermined analysis method and evaluate the defect De inside the target T in detail. As the predetermined analysis method, for example, statistical analysis such as signal intensity or phase analysis, frequency spectrum analysis, or principal component analysis thereof is used to detect and evaluate characteristics including the shape, size, position, and the like of the defect De.

At this time, as described above, since the ultrasound having the intensity less than the predetermined intensity at which the intensity of the ultrasound reflected once by the second surface Sb is not saturated is used, the reflection intensity of the ultrasound reflected to the receiver 23 linearly changes according to the difference in reflection, scattering, or the like at the interface Si of the defect De. Thus, the defect De can be evaluated in detail. For example, the detector (the signal acquirer 24, the first feature amount extractor 31, and the first determiner 32) also considers the time difference Δt1 illustrated in FIG. 2. Thus, the detector may determine the position of the defect De inside the target T, that is, the position between the first surface Sf and the second surface Sb where the defect De is located.

According to the sequence described above, the nondestructive inspection device 1A performs the screening processing Pl and the evaluation processing P2 by using the multiple-reflection signal. Therefore, the nondestructive inspection device 1A can easily determine the presence of the defect De inside the target T, and can further evaluate the characteristics (size, shape, position, and the like) of the defect De.

### Modification Example 3

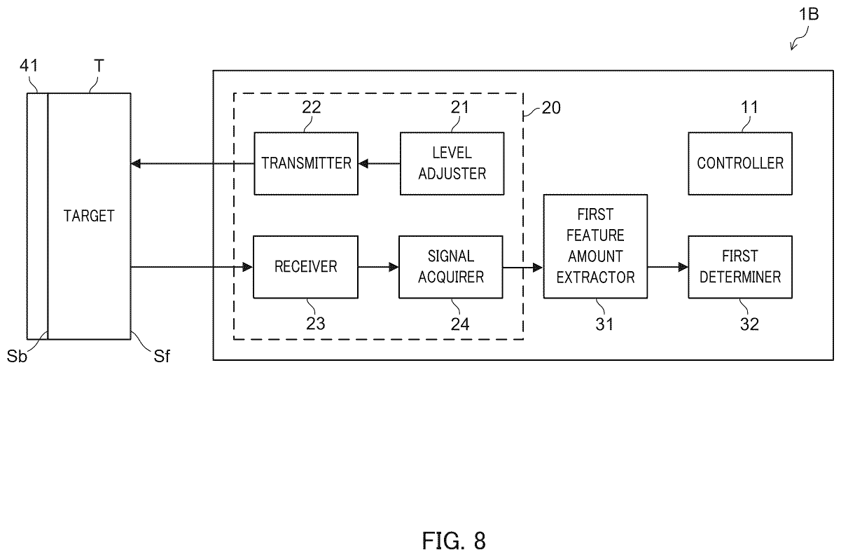

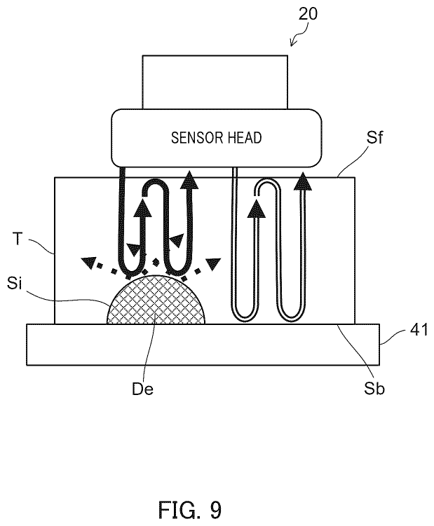

FIG. 8 is a diagram schematically illustrating a nondestructive inspection device 1B that is a modification example of the nondestructive inspection device 1A. FIG. 9 is a diagram illustrating a propagation state of waves input to the target T by the internal information acquirer 20 of the nondestructive inspection device 1B. Also in the present modification example, description will be given using ultrasound as a wave.

The nondestructive inspection device 1B basically has the same configuration as that of the nondestructive inspection device 1A. However, the nondestructive inspection device 1B is different from the nondestructive inspection device 1A in that the nondestructive inspection device 1B includes a reflective medium 41 which is disposed in contact with the outside of the second surface Sb of the target T and increases the reflectance of the second surface Sb with respect to ultrasound in order to enhance a multiple reflection signal. The reflective medium 41 is adjustable so as to increase the reflectance of the second surface Sb to ultrasound, and thus it is possible to enhance the level of a multiple reflection signal.

The reflective medium 41 is disposed in contact with the outside of the second surface Sb opposite to the first surface Sf to which the ultrasound from the transmitter 22 is input. It is desirable that the reflective medium 41 be disposed to face the first surface Sf in parallel or substantially in parallel. Further, it is desirable that the reflective medium 41 is a planar member.

Further, the reflective medium 41 may be applied or bonded to the surface of the second surface Sb. In addition, the reflective medium 41 is not limited to a solid and may be a liquid or a gas as long as the reflective medium 41 has a property of increasing the reflectance of the second surface Sb with respect to the ultrasound.

As described above, the reflective medium 41 that increases the reflectance of the second surface Sb for ultrasound is provided in contact with the outside of the second surface Sb of the target T. Thus, the reflection intensity of the ultrasound increases, and also the intensity of the multiple reflection increases. As a result, the contrast between the area in which the defect De is present and the area in which the defect De is not present can be increased, and the discrimination of the presence of the defect De can be improved.

The nondestructive inspection device 1B can perform the nondestructive inspection method illustrated in FIG. 5 or FIG. 7, and as described above, the contrast between the area in which the defect De exists and the area in which the defect De does not exist is increased, so that the defect De inside the target T can be detected more easily.

### Modification Example 4

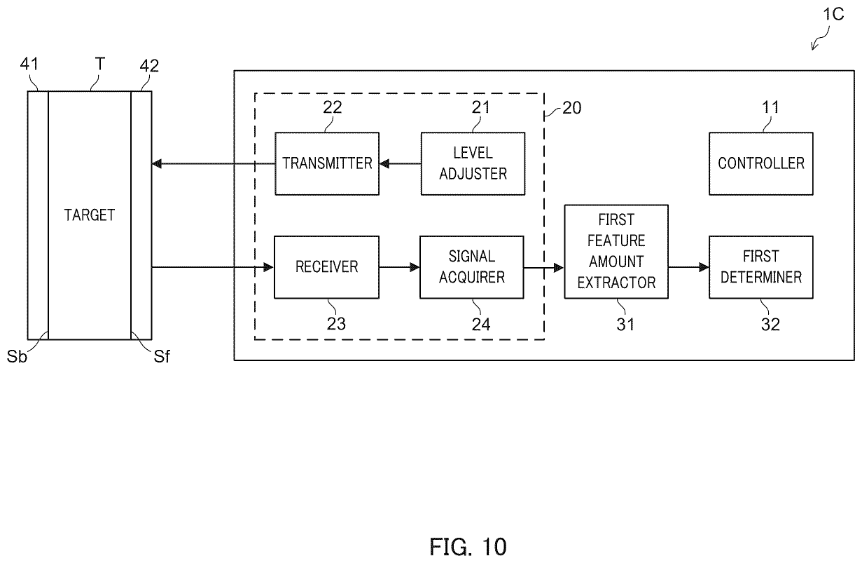

FIG. 10 is a diagram schematically illustrating a nondestructive inspection device 1C that is a modification example of the nondestructive inspection device 1A. FIG. 11 is a diagram illustrating a propagation state of waves input to the target T by the internal information acquirer 20 of the nondestructive inspection device 1C. Also in the present modification example, description will be given using ultrasound as a wave.

The nondestructive inspection device 1C also has basically the same configuration as the nondestructive inspection device 1A. However, the nondestructive inspection device 1C is different from the nondestructive inspection device 1A in that the nondestructive inspection device 1C includes reflective media 41 and 42 disposed in contact with the outside of the first surface Sf and the second surface Sb of the target T and increase the reflectance of the first surface Sf and the second surface Sb with respect to ultrasound in order to enhance a multiple reflection signal.

The reflective medium 41 is as described in the third modification example. Therefore, overlapping description will be omitted here.

The reflective medium 42 is disposed in contact with the outside of the first surface Sf to which the ultrasound from the transmitter 22 is input. It is desirable that the reflective medium 42 is disposed to face the reflective medium 41 in parallel or substantially in parallel. Further, it is desirable that the reflective medium 42 be a planar member.

The reflective medium 42 is adjustable so as to increase the reflectance of the first surface Sf for ultrasound, thus enhancing the level of a multiple reflection signal. That is, the reflective medium 42 adjusts the reflectance of the first surface Sf so as to reflect the ultrasound from the inside of the target T while transmitting the ultrasound transmitted from the transmitter 22 so that the ultrasound is input to the target T.

Further, the reflective medium 42 may be applied or bonded to the surface of the first surface Sf. The reflective medium 42 is not limited to a solid, and may be a liquid or a gas.

In this manner, the reflective media 41 and 42 for adjusting the reflectance of the first surface Sf and the second surface Sb with respect to the ultrasound are provided in contact with the outside of the first surface Sf and the second surface Sb of the target T. Thus, the intensity of the multiple reflection increases. As a result, the contrast between the area in which the defect De is present and the area in which the defect De is not present can be increased, and the discrimination of the presence of the defect De can be improved.

The nondestructive inspection device 1C can also perform the nondestructive inspection method illustrated in FIG. 5 or FIG. 7, and as described above, the contrast between the area in which the defect De is present and the area in which the defect De is not present is increased, so that the defect De inside the target T can be detected more easily.

In addition, in the present modification example, the reflective media 41 and 42 are provided so as to sandwich the target T. Thus, in the present modification example, as illustrated in FIG. 10, even in the target T which does not have a clear flat surface on the outer surface such as an object having an irregular shape, it is possible to generate multiple reflection or increase the intensity of multiple reflection by the reflective media 41 and 42.

### Modification Example 5

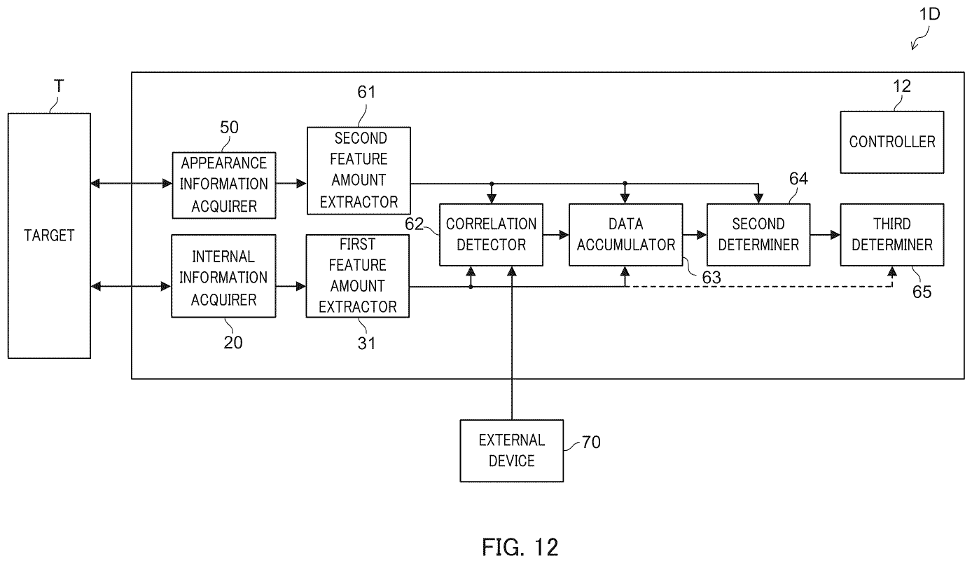

FIG. 12 is a diagram schematically illustrating a nondestructive inspection device 1D that is a modification example of the nondestructive inspection device 1A. Also in the present modification example, description will be given using ultrasound as a wave.

The above-described nondestructive inspection devices 1A to 1C and 1E may be combined with a device that acquires appearance information to determine the presence of a defect inside the target T on the basis of the correlation between the appearance information and the internal information acquired by the nondestructive inspection devices 1A to 1C and 1E.

As such, in the present modification example, the nondestructive inspection device 1D includes a controller 12, an appearance information acquirer 50, a second feature amount extractor 61, a correlation detector 62, a data accumulator 63, a second determiner 64, a third determiner 65, and the like, in addition to a part of the configuration of the nondestructive inspection device 1A.

In the nondestructive inspection device 1D, the internal information acquirer 20 and the first feature amount extractor 31, which are a part of the configuration of the nondestructive inspection device 1A, are as described in the above-described embodiment, and therefore the overlapping description will be omitted here. In addition, instead of the controller 11 and the first determiner 32 of the nondestructive inspection device 1A, the nondestructive inspection device 1D includes the controller 12 and the third determiner 65.

The controller 12 basically has the same configuration as the controller 11 of the nondestructive inspection device 1A, and is a device such as a computer having a CPU, a ROM, a RAM, and the like, for example.

In the controller 12, for example, the CPU refers to a control program and various data stored in the ROM or the RAM and executes the control program. Accordingly, the controller 12 controls the internal information acquirer 20, the first feature amount extractor 31, the appearance information acquirer 50, the second feature amount extractor 61, the correlation detector 62, the data accumulator 63, the second determiner 64, the third determiner 65, and the like, and implements each function.

Note that some or all of these functions may be implemented by a PLD including an ASIC, a DSP, an FPGA, or the like, a dedicated hardware circuit, or the like. Further, some or all of these functions may be configured to be executed by the GPU.

The appearance information acquirer 50 acquires appearance information on the target T. The appearance information acquirer 50 is, for example, a camera (imaging device), and acquires a captured image (two dimensional data) obtained by imaging the outer surface of the target T as the appearance information. The direction (acquisition direction) of the appearance information acquirer 50 with respect to the target T is appropriately adjusted so that, for example, the appearance information is acquired from the input direction of the ultrasound by the transmitter 22 of the internal information acquirer 20 or from the direction along the input direction.

In this modification example, as will be described later, the correlation between the first feature amount extracted by the first feature amount extractor 31 and the second feature amount extracted by the second feature amount extractor 61 is detected. Therefore, the acquisition direction with respect to the target T may be appropriately adjusted so that the appearance information acquirer 50 acquires the appearance information from the direction in which the detected correlation increases.

The second feature amount extractor 61 extracts a feature amount related to a defect inside the target T from the information acquired by the appearance information acquirer 50. Here, the feature amount extracted from the appearance information is referred to as a second feature amount.

The correlation detector 62 detects a correlation between the first feature amount extracted by the first feature amount extractor 31 and the second feature amount extracted by the second feature amount extractor 61, and defect information (size, shape, position, composition, and the like) of the target. Specifically, for example, the internal information and the appearance information on the known target are acquired, and the correlation between the first feature amount and the second feature amount thereof and the defect information on the known target is detected. The internal information, the appearance information, and the defect information of the known target may be acquired from, for example, an external device 70 and the like. Further, the correlation detector 62 may detect the correlation between the first feature amount and the second feature amount, and the defect information using machine learning.

The data accumulator 63 accumulates, as a database, the correlation detected by the correlation detector 62 for the known target.

The second determiner 64 assumes that a database is accumulated in the data accumulator 63. The second determiner 64 determines the presence of a defect inside the target T by referring to the database accumulated in the data accumulator 63 based on the second feature amount extracted from the appearance information with respect to the target to be evaluated which is different from the known target.

In the present modification example, the second feature amount extractor 61 and the second determiner 64 correspond to the detector of the present invention.

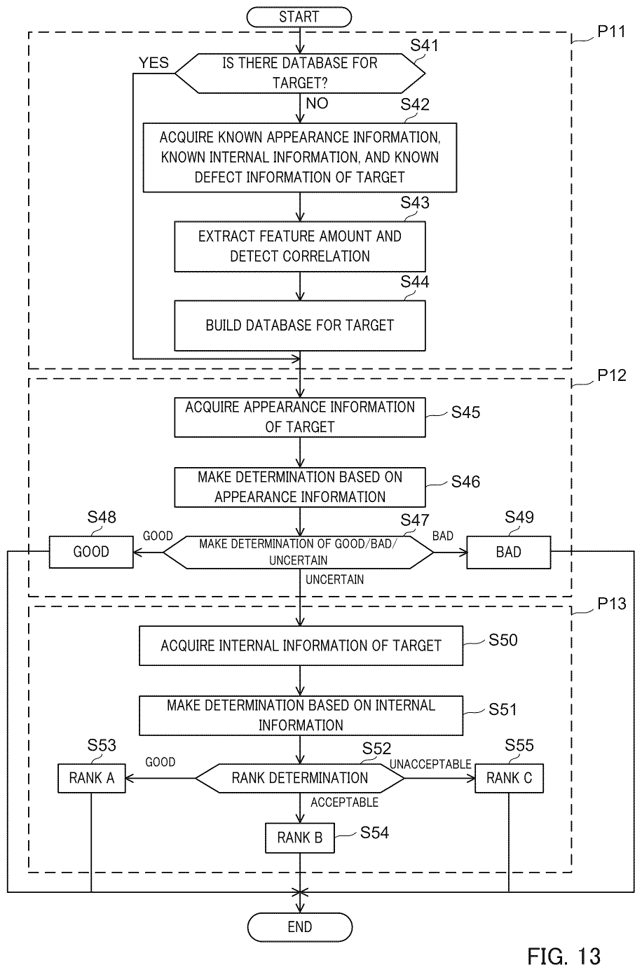

Similarly to the first determiner 32 of the nondestructive inspection device 1A, the third determiner 65 forms a cross-sectional image in a plane along a direction orthogonal to the input direction of the ultrasound on the basis of the first feature amount extracted by the first feature amount extractor 31, and determines the presence of a defect inside the target T. As described later with reference to FIG. 13, when the determination of the presence of a defect by the second determiner 64 is uncertain, the third determiner 65 determines the presence of a defect inside the target T.

### Nondestructive Inspection Method

A nondestructive inspection method in the nondestructive inspection device 1D will be described with reference to FIG. 13. FIG. 13 is a flowchart for explaining an example of a nondestructive inspection method in the nondestructive inspection device 1D. The nondestructive inspection method in the nondestructive inspection device 1D is performed by the controller 12 executing a nondestructive inspection program.

### Step S41

The controller 12 checks whether there is a database for the target T to be inspected. For example, in the data accumulator 63, it is confirmed whether or not there is a database of the correlation between the internal information (first feature amount) and the external appearance information (second feature amount), and the defect information, with respect to the target T to be inspected. When there is a database for the target T to be inspected (YES), the process proceeds to step S45, and when there is no database for the target T to be inspected (NO), the process proceeds to step S42.

### Step S42

The controller 12 acquires known internal information, known external appearance information, and known defect information of the target T to be inspected, for example, from the external device 70. Note that a known target equivalent to the target T to be inspected may be prepared, and the internal information and the appearance information of the known target may be acquired using the inspection device 1D. In this case, known defect information on a known target is input from the operation inputter of the nondestructive inspection device 1D or the external device 70.

### Step S43

The controller 12 controls the correlation detector 62 to extract the first feature amount and the second feature amount from the internal information and the external appearance information and detect the correlation with the defect information.

### Step S44

The controller 12 controls the data accumulator 63 to accumulate the correlations detected by the correlation detector 62 and construct a database for the target T.

The above steps S41 to S44 are construction processing P11 of constructing a database by an object having known information.

### Step S45

The controller 12 controls the appearance information acquirer 50 to acquire appearance information on the target T to be inspected.

### Step S46

The controller 12 controls the second feature amount extractor 61, the data accumulator 63, and the second determiner 64 to make a determination based on the appearance information acquired by the appearance information acquirer 50. Specifically, the second feature amount related to the defect inside the target T is extracted from the appearance information, and the presence of the defect inside the target T is determined with reference to the correlation accumulated in the data accumulator 63 based on the second feature amount.

### Step S47

The controller 12 determines whether the target T is “good”, “bad”, or “uncertain” on the basis of the presence of a defect inside the target T determined by the second determiner 64. Specifically, when there is no defect inside the target T, it is determined as “good”, and the process proceeds to step S48. In addition, when there is a defect inside the target T, it is determined as “bad”, and the process proceeds to step S49. When the presence of a defect inside the target T is uncertain, it is determined as “uncertain”, and the process proceeds to step S50.

### Step S48

The controller 12 displays, for example, “good” on the display, and ends the series of processes.

### Step S49

The controller 12, for example, displays “bad” on the display, provides or displays information such as the position of the defect inside the target T if necessary, and ends the series of processing.

The above steps S45 to S49 are primary determination processing P12 for performing the primary determination on the basis of the appearance information.

### Step S50

The controller 12 controls the internal information acquirer 20 to acquire internal information of the target T to be inspected. The acquisition of the internal information of the target T to be inspected is as described in steps S11 to S13 of the flowchart illustrated in FIG. 5.

### Step S51

The controller 12 controls the internal information acquirer 20 (the signal acquirer 24), the first feature amount extractor 31, and the third determiner 65 to acquire the first signal component representing the internal information from the multiple reflection signal and extract the first feature amount from the signal component. Then, based on the first feature amount, a planar cross-sectional image in a plane along a direction orthogonal to the input direction of the ultrasound is formed, and the defect De inside the target T is determined. Step S51 is basically the same as the processing described in steps S14 to S16 of the flowchart illustrated in FIG. 5.

Note that in step S51 and step S52 described above, step S21 to step S31 of the flowchart illustrated in FIG. 7 may be executed to determine the defect De inside the target T.

### Step S52

The controller 12 determines ranks “A”, “B”, and “C” respectively corresponding to good, acceptable, and unacceptable of the defect on the basis of the presence of the defect inside the target T determined by the third determiner 65. For example, when there is no defect inside the target T (good), it is determined as “A”, and the process proceeds to step S53. In addition, when there is a defect inside the target T but the defect is of a level that does not cause a problem (acceptable), it is determined as “B”, and the process proceeds to step S54. If a defect exists inside the target T and is a problematic defect (unacceptable), it is determined as “C” and the process proceeds to step S55. The number of ranks of defect is not limited to three as described above, and may be smaller or larger.

### Step S53

The controller 12 displays, for example, “rank A” on the display, and ends the series of processing.

### Step S54

The controller 12 displays, for example, “rank B” on the display, provides or displays information such as the position of the defect inside the target T if necessary, and ends the series of processing.

### Step S55

The controller 12, for example, displays “rank C” on the display, provides or displays information such as the position of the defect inside the target T if necessary, and ends the series of processing.

The above-described steps S50 to S55 are secondary determination processing P13 for performing secondary determination on the basis of the internal information.

As described above, in the present modification example, the nondestructive inspection device 1D includes the appearance information acquirer 50 that acquires the appearance information on the target T.

According to the nondestructive inspection device 1D of the present embodiment configured as described above, it is possible to more easily detect the defect De inside the target T using the appearance information. That is, screening for the defect De inside the target T can be performed using the appearance information. When the defect De inside the target T cannot be determined by using the appearance information, the defect De inside the target T can be detected more easily using the multiple reflection signal.

Problems in Each Industrial Field and Effectiveness when Using Nondestructive Inspection Device According to the Present Invention

After the economic growth phase after the big war, depletion of resources and the surfacing of environmental energy problems have brought about a situation where sustainability and secure and safe social development are being demanded worldwide in the future. In response to such a social situation, for the purpose of improvement in production efficiency such as reduction in production loss and energy saving in the field of manufacturing, a further increase in efficiency of an object quality control method is required. In addition, for produced and laid durable materials typified by infrastructures such as bridges, large-scale buildings, and the like, there is also a demand for accurately grasping current quality and characteristics and performing optimal repair and replacement, thereby efficiently maintaining safety at minimum cost. Hereinafter, situations and problems related to quality control of various things in the era of ultra-smart society (Society 5.0) will be described for each industrial field.

In response to the problems described below, the nondestructive inspection devices 1A to 1E according to the present invention provide a simpler method using a multiple reflection phenomenon for a technique of detecting and measuring a subtle difference in the structure or state of the target to be inspected or a change in the structure or state, for the purpose of manufacturing a wide variety of products in small quantities or quality inspection in the era of ultra-smart society.

Further, the nondestructive inspection device 1D according to the present invention is an device and system capable of dramatically reducing the man-hours and cost associated with product quality inspection by utilizing visual information, which is the most simple and widespread nondestructive inspection method, and by constructing a database or performing machine learning or the like using, as input data, the internal information extracted by ultrasonic waves together with visual information, thereby expanding the possibility of detecting internal defects or the like of the subject on the basis of visual information.

As described above, the nondestructive inspection devices 1A to 1E according to the present invention are also related to various manufacturing industries currently in operation, and quality assurance, inspection, and analytical fields related thereto, and are intended to evaluate the internal state of an object. Hereinafter, problems in each industrial field and the effectiveness when the nondestructive inspection device according to the present invention is used will be described.

### Manufacturing Industry

Since the advent of industrial society, the global economy has grown under mass production and mass consumption; however, today, serious issues such as excessive burdens on the global environment and shortages of resources and energy are becoming apparent. As the world population continues to increase, it is becoming difficult to sustain the same economic growth model as before, and the time has come to shift away from the manufacturing method of mass production.

In the super-smart society advocated by the Japanese government, manufacturing that provides “only what is needed, when it is needed” is being promoted. A specific example is the utilization of on-demand production technologies such as 3D printers. In such a context, the known concept of “yield” no longer applies, and every product must meet quality standards. However, in 3D printing, which fabricates products by layering materials, factors such as material inconsistencies, variations in manufacturing environments, contamination by foreign matter, and the occurrence of voids inherently pose greater risks to product quality than traditional manufacturing methods. In other words, there is a demand for technology that enables monitoring of quality during fabrication, allowing for immediate cessation or correction of the process if the quality falls below the standard.

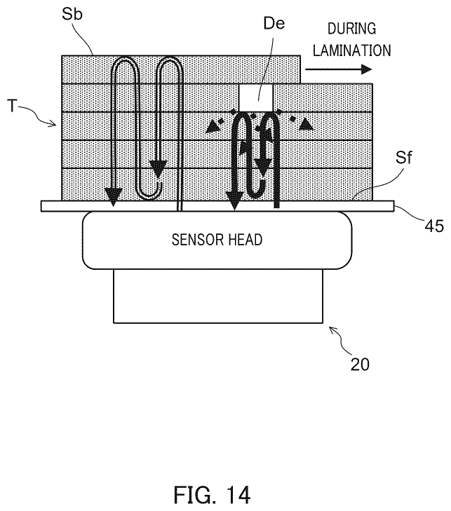

Here, FIG. 14 is a diagram illustrating, as an example, a configuration in which the nondestructive inspection device 1A of the nondestructive inspection devices 1A to 1E according to the present invention is applied to a shaping work by means of a 3D printer. In the example illustrated in FIG. 14, for example, a laminated material formed by means of a 3D printer and constituting the target T is laminated on a base 45, and the internal information acquirer 20 (sensor head) disposed below the base 45 inputs ultrasound to the laminated material via the base 45.

In the example illustrated in FIG. 14, the ultrasound is input from the first surface Sf, which is the lower surface of the laminate constituting the target T, and the stacking work is advanced while monitoring the multiple reflection signal generated between the first surface Sf and the upper surface (for example, the second surface Sb which is the uppermost surface in the lamination) or the like of the laminate. Then, when the occurrence of the defect De such as a void in the stacked object is detected, the stacking work is immediately stopped, or the stacking work is restarted after an appropriate treatment (for example, a repair treatment of the defect De) is performed.

By applying the nondestructive inspection device 1A according to the present invention to the shaping work by the 3D printer, the shaping work can be performed while monitoring the quality, and when the quality is below a standard, the shaping can be advanced while promptly stopping or correcting. This is the same even in a case where the nondestructive inspection devices 1B to 1E according to the present invention are applied to shaping work by means of a 3D printer.

Note that the above-described reflective medium 42 may be used as the base 45 illustrated in FIG. 14, and thus, the intensity of multiple reflection can be increased, thereby more reliably detecting the occurrence of the defect De during the shaping work.

As described above, the nondestructive inspection devices 1A to 1E according to the present invention can easily monitor an internal defect or the like of a target in real time, and thus are effective technologies in the present field.

### Food Processing

In recent years, alongside resources and energy, food shortages are becoming a global issue. As a result, attention is being directed toward food sources that have not traditionally been recognized as such, such as insects, as well as food ingredients that are processed and treated more artificially than ever before.

On the other hand, the aging of society and increasing health consciousness, particularly in developed countries, are driving greater demands for higher quality and safety in food products, and this trend is expected to continue and intensify in the future. Therefore, taking the above circumstances into consideration, the demand for quality control and monitoring of foreign matter contamination in the production and processing of food products is expected to increase further.

The nondestructive inspection devices 1A to 1E according to the present invention, in particular, the nondestructive inspection device 1C is an effective technology in the present field because it is possible to simply monitor, in real time, a foreign substance or the like inside a target having an indefinite shape such as a food product.

### Quality Assurance

As described above, in a super-smart society, the production style is shifting from mass production to on-demand manufacturing of a wide variety of products. Along with this shift, the approach to product quality assurance and safety is also changing, with full inspection becoming the standard rather than sampling inspection from the same lot. In other words, there is a need for inspection methods that can simply and efficiently measure diverse objects and obtain data related to quality.

The nondestructive inspection devices 1A to 1E according to the present invention can easily perform inspection on any target by using safe non-exposure ultrasound, and are effective technologies in the present field.

### Inspection and Analysis

Lightweight and high-rigidity materials such as carbon fiber reinforced plastics (CFRP) are increasingly being adopted in aircraft, automobiles, and other applications as one of the measures toward realizing a low-carbon society, and it is essential to ensure sufficient strength of such materials.

In the related art, strength assurance of products has mainly relied on a combination of “sampling” and “destructive testing,” which assumes mass production. In contrast, CFRP is not well-suited for mass production due to structural and manufacturing constraints, and even with carbon fiber reinforced thermoplastics (CFRTP), which offer improved production efficiency, on-demand production is expected to become mainstream in a super-smart society.

In quality assurance and inspection of products manufactured in small quantities and in various types, direct evidence based on data obtained from the actual product is required, rather than logic or mechanisms that provide only indirect evidence regarding final performance. Therefore, there is a demand for inspection methods that can easily and accurately acquire data related to quality.

The nondestructive inspection devices 1A to 1E according to the present invention can also observe the internal state of a new composite material such as CFRP by using ultrasound excellent in permeability, and are effective technologies in the present field.

### Reliability, Safety, and Life Expectancy Management of Finished Products

The slowdown of economic growth and the issues of resource and energy shortages in developed countries are prompting a reexamination of known economic activities based on a scrap-and-build approach and disposable consumption behaviors, urging a shift toward a lifestyle that emphasizes prolonged use of limited resources, products, and structures.

Current standards for the safety and durability of aircraft, automobiles, and infrastructure, while having a certain degree of logical basis, are largely grounded in empirical practices and stipulate regular inspections based on generous safety margins. However, in a future sustainable society, it will be essential to ensure continued safe use of products and structures by performing minimal and timely maintenance or repairs based on sufficient evidence, thereby reducing the cost and resource burden for upkeep. To achieve this, simple yet highly accurate inspection methods will be required.

The nondestructive inspection devices 1A to 1E according to the present invention are excellent in economic efficiency in terms of hardware and software and can perform daily quality control of a target by using ultrasound that can be handled by anyone without qualification, and thus are effective technologies in the present field.

### Quality Control of Pharmaceuticals

The spread of COVID-19 clearly demonstrated that a global pandemic can still occur even in the modern era of advanced medicine. Although its origin remains unclear, the advancement of biological research can arguably increase such risks.

In a super-smart society, innovation in manufacturing is advancing toward on-demand production, and in the medical field, personalization is also gaining attention. However, with regard to pharmaceuticals, it is expected that, due to the nature of clinical trials, the industry will inevitably continue to rely on mass production for the foreseeable future.

In Japan as well, contamination of vaccines with foreign matter has become a concern, and stricter inspections are expected to be required in the future. However, there are limited methods for inspecting a large quantity of packaged and sealed liquid externally. Optical or image-based inspection is one of the most promising methods, but it becomes ineffective if the packaging or the liquid itself is colored, thus a method that is not affected by color is desired.

The nondestructive inspection devices 1A to 1E according to the present invention enable easy inspection without being influenced by color by using ultrasound, and are effective technologies in the present field.

### Recycling Industry

As described above, CFRP is a key material for realizing a low-carbon society; however, the recycling of used CFRP (rCF) remains a challenge. This is because rCF tends to exhibit greater quality degradation and variability compared to the use of fresh materials. To address this, a major rCF manufacturer in the United Kingdom classifies waste CFRP into 24 categories before proceeding with cutting and pulverization in order to produce rCF with stable physical properties. Nevertheless, there are still few rCF products that can be applied in cases where high strength is required.

The emergence of simpler and more efficient methods for evaluating the quality of waste CFRP and rCF could broaden the scope of composite material utilization and potentially contribute to solving social issues.

The nondestructive inspection devices 1A to 1E according to the present invention can be operated in a flexible use method and use form even for commercialized CFRP, and are effective technologies in the present field.

### Sharing Services

Due to the slowdown in economic growth, particularly in developed countries, the aging of society, the shift from a goods-oriented culture to an experience-oriented culture leading to a decline in the status of ownership, and recent global developments such as geopolitical bloc formation resulting in material and resource shortages, interest in sharing services is expected to grow in the future.

With regard to car sharing, which is one of the representative forms of sharing services, the handling of life-critical assets makes routine inspection and management more essential than ever before. However, while vehicle inspections for privately owned cars involve an aspect of “self-management,” in the era of sharing, issues such as responsibility and cost allocation come to the fore. In this context, the known system of conducting inspections every two to three years at high cost is no longer adequate, and there is a need to establish means and systems that can ensure vehicle safety more routinely and at lower cost.

Further, for vehicles made of lightweight composite materials, the use of which is expected to increase in the future, technologies that enable easy inspection of the strength of the vehicle body and structures will be required.

The nondestructive inspection devices 1A to 1E according to the present invention have high economic efficiency by using ultrasound and can be routinely handled by anyone, and thus are effective technologies in the present field.

Next, based on the technical trends and problems of nondestructive inspection used as a quality control method in each of the above-described fields, the positioning and effectiveness of the nondestructive inspection device according to the present invention will be described.

### Current Status and Challenges of Nondestructive Inspection (Visual Inspection)

As described in the Ministry of Economy, Trade and Industry's “DX Report 2” (December 2020), “Digital Transformation (DX)” is being promoted to transform research and development as well as organizational structures for the purpose of “value creation in response to market needs.”

In the context of DX in manufacturing, active efforts are being made to provide visual inspection solutions that combine camera images with AI technologies, as well as to conduct research and development of elemental technologies related to nondestructive inspection.

It is difficult for known simple image processing to handle tasks such as distinguishing slight scratches on the surface of an object, differences in surface treatment, or subtle nuances in color tone, as well as making judgments of acceptability or abnormality based on such distinctions. As a result, many analog workplaces (hereinafter referred to as AWP) still rely on the “intuition, techniques, and experience” of skilled workers and veteran technicians without having been automated. In such workplaces, the transfer of evaluation technologies and know-how is challenging, which not only hampers improvements in work efficiency but also poses a serious issue where the retirement or departure of technicians can lead directly to the loss of skills and expertise, becoming a significant barrier for future manufacturing.

In contrast, once a learning model using AI is constructed and implemented, tasks that previously required multiple personnel for visual inspection can be digitized using camera images and machine learning, thereby reducing workload and improving inspection efficiency. Further, by formalizing and converting the “intuition, techniques, and experience” of skilled workers into data, it becomes possible to apply and pass down more precise and detailed inspection tasks on a broader scale. This enables the transformation of analog workplaces (AWP) into digital workplaces (DWP), thereby further advancing the digital transformation (DX) of manufacturing.

### Challenge 1: Establishment of an Environment for Acquiring Large Volumes of Data

In order to train AI to perform the delicate and critical tasks described above, it is necessary to acquire a large volume of data for training purposes.

However, in many manufacturing industries, not only has DX (Digital Transformation) not been realized, but even the digitalization of individual operations and manufacturing processes, i.e., “digitalization”, has not yet been achieved in many cases. Further, there are still numerous instances where even the digitization of analog or physical data, i.e., “digitization”, remains incomplete.

Skipping digitization and digitalization to directly transition to DX is not impossible; however, if the current methods are to remain the basis, significant challenges will be encountered. To overcome these challenges, some form of new method or approach is required.

Further, in primary industries, large-scale data acquisition has been conducted even less frequently than in manufacturing (secondary industries). In the food-related sector, the introduction of HACCP (Hazard Analysis and Critical Control Points), which became mandatory in June 2020, involves subdividing the manufacturing process and managing risks at each stage to prevent the shipment of problematic products. A key feature of HACCP is that, in the event of a food safety incident, it allows for rapid identification of the process step responsible. Therefore, although data-driven approaches are expected to become mainstream in the food industry in the future, it is clear that building mechanisms for data acquisition, particularly in primary industries, will be a major challenge going forward. Accordingly, there is a growing need for new, simple, and effective means or methods of data acquisition.

The nondestructive inspection device 1D according to the present invention is an effective technology in solving the above-described problem, since it is possible to acquire a greater amount of information by using internal information obtained by means of ultrasound in addition to a captured image of the appearance of a target.

### Challenge 2: Acquisition of High-Quality Data Capable of Handling Analog-Level Quality

In visual inspection, excessive detection can lead to decreased manufacturing efficiency, and in the case of agricultural products and the like, it is necessary to accurately perform multi-level grading rather than simple binary judgments of pass/fail. Therefore, in order to convert such analog tasks, traditionally reliant on the know-how of skilled workers and engineers, into data and to construct AI learning models, it is essential to prepare extremely high-quality data as a foundation.

In the related art, the most reliable way to obtain high-quality data has been through the use of advanced analytical equipment. However, this approach requires significant time, labor, and cost, potentially making data acquisition itself the bottleneck in the realization of DX.

On the other hand, in some themes of the Ultra-Advanced Materials Ultra-Fast Development Platform Technology Project (commonly known as the “Ultra-Ultra Project”) launched in Japan in 2016, there have been numerous cases where computer simulations, initially used for logical understanding, were rationally utilized as a means of generating input data for AI. However, even in these cases, the need for supercomputers results in substantial computational costs, which can also become an obstacle to achieving DX.

Therefore, there is a need for data acquisition means or methods for manufacturing that are neither virtual data, such as those from computer simulations, nor low-productivity real data obtained using known advanced equipment.

Further, in the visual inspection of products, subtle sensory attributes such as texture or tactile feel, which may not be accurately perceived or verbalized by human senses, can influence the judgment of acceptability. However, these attributes are difficult to digitize even when using sensors that digitally replicate human senses, presenting a significant challenge.

To address this issue, it is conceivable to introduce various sensing technologies that operate on evaluation axes different from human senses, and to extract correlations with the sensory indicators that are originally intended to be evaluated. In other words, it is necessary to prepare a variety of sensing devices and acquire multidimensional measurement parameters in order to digitize sensory indicators.

The nondestructive inspection device 1D according to the present invention is an effective technology in solving the above-described problem, since it is possible to multi-dimension an evaluation parameter by using internal information obtained by ultrasound in addition to a captured image of the appearance of a target.

### Challenge 3: The Need for Inspection Methods That Can Provide Feedback to Upstream Manufacturing Processes

As the term suggests, visual inspection evaluates only the appearance of a product, with the inspection limited to its surface shape and surface condition. Therefore, even if implemented within the manufacturing process, it cannot provide information about the internal or reverse-side conditions (such as structure or composition) of the product. It is limited to a final, external evaluation of the product at the inspection stage.

On the other hand, the surface shape and condition of a product can sometimes reflect its internal structure or composition. For example, warping in plastic products may be caused by residual stress within the resin. In such cases, while a simple visual inspection can detect the presence or absence of warping, it cannot assess whether the warping is due to internal stress. In other words, even if a defect is detected, it is not possible to identify which process step caused the issue. Although visual inspection may contribute to sorting the final products, the labor and materials invested in producing the rejected defective items are lost, and such losses only increase with the recurrence of similar defects. Therefore, known visual inspection has a limitation in reaching the essence of manufacturing DX.

The nondestructive inspection device 1D according to the present invention is an effective technique in solving the above-described problems, since it is possible to introduce not only the appearance information but also the evaluation parameter reflecting the internal state by using the ultrasound measurement in addition to the captured image of the appearance of the object.

Challenge 4: The Need for a Method to Inspect Internal Conditions with High Operational Efficiency

To address the above challenges, it is conceivable to combine visual inspection with internal inspection within the manufacturing process. However, internal inspection generally requires more labor and cost than visual inspection, making full-scale internal inspection for every product impractical due to associated losses. Therefore, even in visual inspection, it is necessary to propose a method that, by increasing the dimensionality of evaluation parameters as described earlier, can associate with internal information (such as structure or material composition) and extract features that cannot be detected through known inspection.

The nondestructive inspection device 1D according to the present invention detects a correlation between a captured image data of an appearance of a target and an internal information data by ultrasound and forms a database, thereby enabling a highly accurate inspection with minimum man-hours, and is an effective technology in solving the above-described problem.

The above-described embodiment is merely an example for implementing the present invention, and the technical scope of the present invention should not be interpreted in a limited manner by these embodiments. That is, the present invention can be implemented in various forms without departing from the spirit or main features thereof.

The disclosure of the specification, drawings and abstract contained in the Japanese Patent Application No. 2023-017659 Japanese patent application filed on Feb. 8, 2023 is incorporated herein by reference in its entirety.

### DESCRIPTION OF SYMBOLS

1a, 1b, 1c, 1d, 1e Nondestructive inspection device
11, 12 Controller
20 Internal information acquirer
21 Level adjuster
22 Transmitter
23 Receiver
24 Signal acquirer
25 Acquisition timing adjuster
31 First feature amount extractor
32 First determiner
41, 42 Reflective medium
50 Appearance information acquirer
61 Second feature amount extractor
62 Correlation detector
63 Data accumulator
64 Second determiner
65 Third determiner
70 External device

1. A nondestructive inspection device, comprising:
a transmitter that transmits a wave to a target;
a receiver that receives the wave that is reflected; and
a detector that acquires internal information on the target based on the wave reflected a plurality of times in the wave that is reflected and detects a defect inside the target based on the internal information, the wave reflected the plurality of times being reflected the plurality of times between a plurality of interfaces including an outer surface of the target.

2. The nondestructive inspection device according to claim 1,
wherein the transmitter inputs the wave from a first surface among a plurality of surfaces constituting the outer surface;
wherein the receiver receives the wave reflected a plurality of times between the first surface and a second surface different from the first surface among the plurality of surfaces constituting the outer surface and converts the wave into a first reception signal; and
wherein the detector includes:
at least one hardware processor,
wherein the at least one hardware processor
acquires a first signal component representing the internal information from the first reception signal;
extracts a first feature amount related to the defect from the first signal component; and
forms a cross-sectional image in a plane along a direction orthogonal to an input direction of the wave based on the first feature amount, and determines presence of the defect.

3. The nondestructive inspection device according to claim 2, wherein the first surface and the second surface face each other in a parallel manner or a substantially parallel manner.

4. The nondestructive inspection device according to claim 2,
wherein the transmitter sets an intensity of the wave to be input to the target to an intensity equal to or higher than a predetermined intensity; and
wherein the predetermined intensity is an intensity at which a signal level, at the receiver, of the wave reflected once by the second surface is an upper limit signal level allowed at the receiver.

5. The nondestructive inspection device according to claim 2, wherein the at least one hardware processor provides the signal acquirer with a signal or information indicating at least one of a timing and a time length for acquiring the first signal component from the first reception signal in accordance with the number of reflections of the wave.

6. The nondestructive inspection device according to claim 2, further comprising a medium that is disposed in contact with an outer side of at least one of the first surface and the second surface and is capable of adjusting a reflectance of the first surface and the second surface for the wave.

7. The nondestructive inspection device according to claim 2, wherein at least one of the first surface and the second surface is formed by bringing a planar member into contact with the outer surface of the target.

8. The nondestructive inspection device according to claim 2, wherein the transmitter and the receiver are arranged such that a first effective distance based on a first distance between an input/output end surface and the first surface is not N times a second effective distance based on a second distance between the first surface and the second surface when the at least one hardware processor acquires the first signal component from a reception signal corresponding to the wave reflected N times by the second surface in the first reception signal, the input/output end surface being a wave input/output end surface of the transmitter and the receiver, and the N being a natural number.

9. The nondestructive inspection device according to claim 8,
wherein the first effective distance is a distance based on the first distance and a refractive index of a space between the input/output end surface and the first surface; and
wherein the second effective distance is a distance based on the second distance and a refractive index of the target.

10. The nondestructive inspection device according to claim 2,
wherein the receiver receives the wave reflected once by an inside of the target and the second surface among the inside of the target, the first surface, and the second surface, and converts the wave into a second reception signal; and
wherein the detector determines presence of the defect based on the first reception signal and the second reception signal.

11. The nondestructive inspection device according to claim 2, wherein the at least one hardware processor extracts the first feature amount based on intensity information of the first signal component.

12. The nondestructive inspection device according to claim 2, wherein the at least one hardware processor extracts the first feature amount based on phase information of the first signal component.

13. The nondestructive inspection device according to claim 2, wherein the at least one hardware processor extracts the first feature amount based on frequency information of the first signal component.

14. The nondestructive inspection device according to claim 2, wherein the at least one hardware processor extracts the first feature amount based on spatial frequency information of the first signal component in the plane along the direction orthogonal to the input direction of the wave.

15. The nondestructive inspection device according to claim 2, wherein the at least one hardware processor extracts the first feature amount based on any two or more of intensity information of the first signal component, phase information of the first signal component, frequency information of the first signal component, and spatial frequency information of the first signal component in the plane along the direction orthogonal to the input direction of the wave.

16. The nondestructive inspection device according to claim 2, wherein the at least one hardware processor determines the presence of the defect by forming contour data obtained by differentiating data of the cross-sectional image in a direction along the direction orthogonal to the input direction of the wave.

17. The nondestructive inspection device according to claim 4, wherein when the at least one hardware processor determines the presence of the defect,
the transmitter re-inputs a wave having an intensity less than the predetermined intensity to an area in which the defect exists;
the receiver receives and converts the wave, having an intensity less than the predetermined intensity, reflected inside the target into a third reception signal, and
the detector detects characteristics including a shape, a size, and a position of the defect based on the third reception signal.

18. (canceled)

19. (canceled)

20. (canceled)

21. (canceled)

22. (canceled)

23. (canceled)

24. (canceled)

25. The nondestructive inspection device according to claim 1, wherein the wave is any one of an acoustic wave, an electromagnetic wave, and a light wave.

26. A nondestructive inspection method, comprising:
transmitting a wave to a target;
receiving the wave that is reflected; and
acquiring internal information on the target based on the wave reflected a plurality of times in the wave that is reflected and detecting a defect inside the target based on the internal information, the wave reflected the plurality of times being reflected the plurality of times between a plurality of interfaces including an outer surface of the target.

27. A non-transitory computer-readable recording medium storing a nondestructive inspection program that causes a computer to execute:
a process of transmitting a wave to a target;
a process of receiving the wave that is reflected; and
a process of acquiring internal information on the target based on the wave reflected a plurality of times in the wave that is reflected and detecting a defect inside the target based on the internal information, the wave reflected the plurality of times being reflected the plurality of times between a plurality of interfaces including an outer surface of the target.
